(19) United States
(12) Patent Application Publication
(10) Pub. No.: US 2013/0326199 A1
(43) Pub. Date: Dec. 5, 2013

(54) METHOD AND APPARATUS FOR CONTROLLING A MXCSR

(71) Applicants: Grigorios Magklis, Barcelona (ES); Josep M. Codina, Hospitalet de Llobregat (ES); Craig B. Zilles, Santa Clara, CA (US); Michael Neilly, Santa Clara, CA (US); Sridhar Samudrala, Austin, TX (US); Alejandro Martinez Vicente, Barcelona (ES); Polychronis Xekalakis, Barcelona (ES); F. Jesus Sanchez, Barcelona (ES); Marc Lupon, Barcelona (ES); Georgios Tournavitis, Barcelona (ES); Enric Gibert Codina, Barcelona (ES); Crispin Gomez Requena, Valencia (ES); Antonio Gonzalez, Barcelona (ES); Mirem Hyuseinova, Barcelona (ES); Christos E. Kotselidis, Linz (AT); Fernando Latorre, Barcelona (ES); Pedro Lopez, Molins de Rei (ES); Carlos Madriles Gimeno, Barcelona (ES); Pedro Marcuello, Barcelona (ES); Raul Martinez, Barcelona (ES); Daniel Ortega, Barcelona (ES); Demos Pavlou, Barcelona (ES); Kyriakos A. Stavrou, Barcelona (ES)

(72) Inventors: Grigorios Magklis, Barcelona (ES); Josep M. Codina, Hospitalet de Llobregat (ES); Craig B. Zilles, Santa Clara, CA (US); Michael Neilly, Santa Clara, CA (US); Sridhar Samudrala, Austin, TX (US); Alejandro Martinez Vicente, Barcelona (ES); Polychronis Xekalakis, Barcelona (ES); F. Jesus Sanchez, Barcelona (ES); Marc Lupon, Barcelona (ES); Georgios Tournavitis, Barcelona (ES); Enric Gibert Codina, Barcelona (ES); Crispin Gomez Requena, Valencia (ES); Antonio Gonzalez, Barcelona (ES); Mirem Hyuseinova, Barcelona (ES); Christos E. Kotselidis, Linz (AT); Fernando Latorre, Barcelona (ES); Pedro Lopez, Molins de Rei (ES); Carlos Madriles Gimeno, Barcelona (ES); Pedro Marcuello, Barcelona (ES); Raul Martinez, Barcelona (ES); Daniel Ortega, Barcelona (ES); Demos Pavlou, Barcelona (ES); Kyriakos A. Stavrou, Barcelona (ES)

(21) Appl. No.: 13/995,416

(22) PCT Filed: Dec. 29, 2011
(86) PCT No.: PCT/US11/67957

§ 371 Date: Jun. 18, 2013

(51) Int. Cl. G06F 9/30

(52) U.S. Cl. CPC G06F 9/3001
USPC 712/222

(57) ABSTRACT

Disclosed is an apparatus and method generally related to controlling a multimedia extension control and status register (MXCSR). A processor core may include a floating point unit (FPU) to perform arithmetic functions; and a multimedia extension control register (MXCR) to provide control bits to the FPU. Further an optimizer may be used to select a speculative multimedia extension status register (SPEC_MXSR) from a plurality of SPEC_MXSRs to update a multimedia extension status register (MXSR) based upon an instruction.

### BACKGROUND

1. Field of the Invention

Embodiments of the invention generally relate to a method and apparatus for controlling a Multimedia Extension Control and Status Register (MXCSR).

2. Description of the Related Art

The Multimedia Extension Control and Status Register (MXCSR) holds IEEE floating-point control and status information—the status information being arithmetic flags. The control bits are the inputs to every floating-point operation and the arithmetic flags are outputs of every floating-point operation. If a floating-point operation produces arithmetic flags that are not “masked” by a corresponding control bit, a floating-point exception must be raised. Arithmetic flags are sticky, i.e., once set by an operation they cannot be cleared.

This makes MXCSR a serialization point for all floating-point operations. Out-of-order processors exist today that employ some form of renaming and reordering mechanisms for the MXCSR to allow floating-point operations to be executed out of program order. These mechanisms may attach a speculative copy of the arithmetic flags produced by each instruction to the result of the instruction, and when the instruction retires the flags are merged to the architectural version and exceptions are checked. Unfortunately, this mechanism is purely implemented in hardware and only the order of the selected program is known and it cannot be changed or manipulated.

### BRIEF DESCRIPTION OF THE DRAWINGS

A better understanding of the present invention can be obtained from the following detailed description in conjunction with the following drawings, in which:

FIG. 1 illustrates a computer system architecture that may be utilized with embodiments of the invention.

FIG. 2 illustrates a computer system architecture that may be utilized with embodiments of invention.

FIG. 3 is a block diagram of processor core including a floating-point arithmetic unit (FPU) that executes floating-point arithmetic functions.

FIG. 4 is block diagram illustrating two registers: architecture ARCH_MXCR and ARCH_MXSR; and an optimizer to control the MXCSR for FPU operations, according to one embodiment of the invention.

FIG. 5 is a diagram that shows examples of merge, rotate, clear, and MXRE instructions in digital gate form, according to one embodiment of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

The following are exemplary computer systems that may be utilized with embodiments of the invention to be hereinafter discussed and for executing instruction(s) detailed herein. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

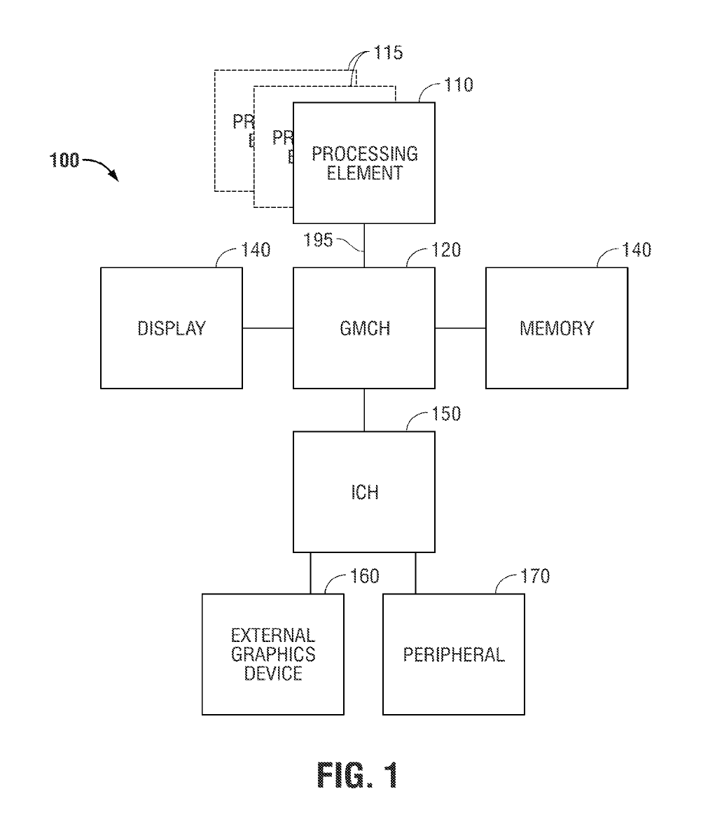

Referring now to FIG. 1, shown is a block diagram of a computer system 100 in accordance with one embodiment of the present invention. The system 100 may include one or more processing elements 110, 115, which are coupled to graphics memory controller hub (GMCH) 120. The optional nature of additional processing elements 115 is denoted in FIG. 1 with broken lines. Each processing element may be a single core or may, alternatively, include multiple cores. The processing elements may, optionally, include other on-die elements besides processing cores, such as integrated memory controller and/or integrated I/O control logic. Also, for at least one embodiment, the core(s) of the processing elements may be multithreaded in that they may include more than one hardware thread context per core.

FIG. 1 illustrates that the GMCH 120 may be coupled to a memory 140 that may be, for example, a dynamic random access memory (DRAM). The DRAM may, for at least one embodiment, be associated with a non-volatile cache. The GMCH 120 may be a chipset, or a portion of a chipset. The GMCH 120 may communicate with the processor(s) 110, 115 and control interaction between the processor(s) 110, 115 and memory 140. The GMCH 120 may also act as an accelerated bus interface between the processor(s) 110, 115 and other elements of the system 100. For at least one embodiment, the GMCH 120 communicates with the processor(s) 110, 115 via a multi-drop bus, such as a frontside bus (FSB) 195. Furthermore, GMCH 120 is coupled to a display 140 (such as a flat panel display). GMCH 120 may include an integrated graphics accelerator. GMCH 120 is further coupled to an input/output (I/O) controller hub (ICH) 150, which may be used to couple various peripheral devices to system 100. Shown for example in the embodiment of FIG. 1 is an external graphics device 160, which may be a discrete graphics device coupled to ICH 150, along with another peripheral device 170.

Alternatively, additional or different processing elements may also be present in the system 100. For example, additional processing element(s) 115 may include additional processors(s) that are the same as processor 110, additional processor(s) that are heterogeneous or asymmetric to processor 110, accelerators (such as, e.g., graphics accelerators or digital signal processing (DSP) units), field programmable gate arrays, or any other processing element. There can be a variety of differences between the physical resources 110, 115 in terms of a spectrum of metrics of merit including architectural, microarchitectural, thermal, power consumption characteristics, and the like. These differences may effectively manifest themselves as asymmetry and heterogeneity amongst the processing elements 110, 115. For at least one embodiment, the various processing elements 110, 115 may reside in the same die package.

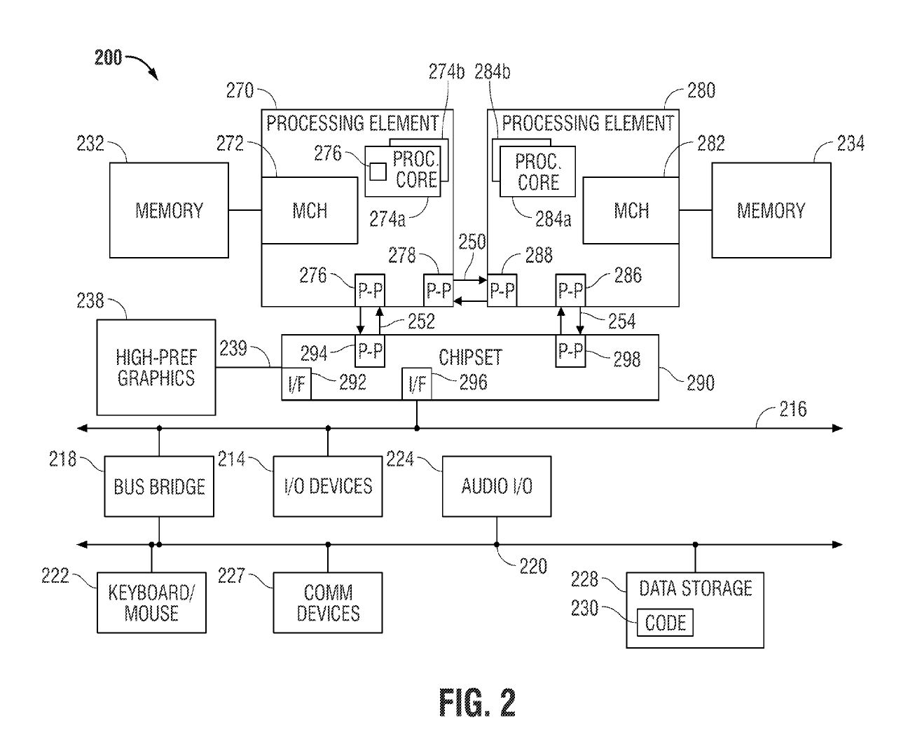

Referring now to FIG. 2, shown is a block diagram of another computer system 200 in accordance with an embodiment of the present invention. As shown in FIG. 2, multiprocessor system 200 is a point-to-point interconnect system, and includes a first processing element 270 and a second processing element 280 coupled via a point-to-point interconnect 250. As shown in FIG. 2, each of processing elements 270 and 280 may be multicore processors, including first and second processor cores (i.e., processor cores 274a and 274b and processor cores 284a and 284b). Alternatively, one or more of processing elements 270, 280 may be an element other than a processor, such as an accelerator or a field programmable gate array. While shown with only two processing elements 270, 280, it is to be understood that the scope of the present invention is not so limited. In other embodiments, one or more additional processing elements may be present in a given processor.

First processing element 270 may further include a memory controller hub (MCH) 272 and point-to-point (P-P) interfaces 276 and 278. Similarly, second processing element 280 may include a MCH 282 and P-P interfaces 286 and 288. Processors 270, 280 may exchange data via a point-to-point (PtP) interface 250 using PtP interface circuits 278, 288. As shown in FIG. 2, MCH's 272 and 282 couple the processors to respective memories, namely a memory 242 and a memory 244, which may be portions of main memory locally attached to the respective processors.

Processors 270, 280 may each exchange data with a chipset 290 via individual PtP interfaces 252, 254 using point to point interface circuits 276, 294, 286, 298. Chipset 290 may also exchange data with a high-performance graphics circuit 238 via a high-performance graphics interface 239. Embodiments of the invention may be located within any processing element having any number of processing cores. In one embodiment, any processor core may include or otherwise be associated with a local cache memory (not shown). Furthermore, a shared cache (not shown) may be included in either processor outside of both processors, yet connected with the processors via p2p interconnect, such that either or both processors' local cache information may be stored in the shared cache if a processor is placed into a low power mode. First processing element 270 and second processing element 280 may be coupled to a chipset 290 via P-P interconnects 276, 286 and 284, respectively. As shown in FIG. 2, chipset 290 includes P-P interfaces 294 and 298. Furthermore, chipset 290 includes an interface 292 to couple chipset 290 with a high performance graphics engine 248. In one embodiment, bus 249 may be used to couple graphics engine 248 to chip set 290. Alternately, a point-to-point interconnect 249 may couple these components. In turn, chipset 290 may be coupled to a first bus 216 via an interface 296. In one embodiment, first bus 216 may be a Peripheral Component Interconnect (PCI) bus, or a bus such as a PCI Express bus or another third generation I/O interconnect bus, although the scope of the present invention is not so limited.

As shown in FIG. 2, various I/O devices 214 may be coupled to first bus 216, along with a bus bridge 218 which couples first bus 216 to a second bus 220. In one embodiment, second bus 220 may be a low pin count (LPC) bus. Various devices may be coupled to second bus 220 including, for example, a keyboard/mouse 222, communication devices 226 and a data storage unit 228 such as a disk drive or other mass storage device which may include code 230, in one embodiment. Further, an audio I/O 224 may be coupled to second bus 220. Note that other architectures are possible. For example, instead of the point-to-point architecture of, a system may implement a multi-drop bus or other such architecture.

As will be described, embodiments of the invention relate to an optimizer to expose the hardware of a Multimedia Extension Control and Status Register (MXCSR) of the processor core (e.g., 274 and 284) to enable reordering, renaming, tracking, and exception checking to allow for the optimization of floating-point operations by an application—including but not limited to a dynamic compilation system such as a dynamic binary translator or a just-in-time compiler—or an application programmer. It should be appreciated that the term “application” hereinafter also refers to dynamic compilation systems.

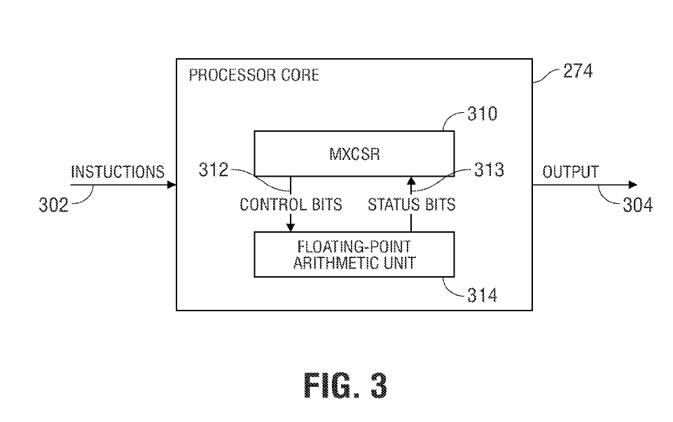

First, turning to FIG. 3, a description of MXCSR operation will be described. It should be appreciated that there are two points of view of a communication with a processor core 274 of a computing system. The first point of view is what the application or the application programmer “sees”, that is the interface that the application or the application programmer uses to communicate instructions 302 and to receive output 304 from the processor core 274. This interface may be termed the PROCESSOR LOGICAL VIEW. The application state in the logical view may be termed the ARCHITECTURAL STATE or LOGICAL STATE.

The second point of view is what the processor core 274 implements “under the hood” or “unseen” by the application or the application programmer, in order to execute the application in an efficient way. The application state is the actual internal implementation by the core processor 274 which may be termed the PHYSICAL STATE.

As shown in FIG. 3, when executing floating-point arithmetic instructions in a processor core 274, the processor core 274 implements a floating-point arithmetic unit (FPU) 314, which executes the relevant instructions 302. In order to accomplish this, the MXCSR 310 controls the behavior of the FPU 314 through control bits 312 and receives status updates 313 (arithmetic flags) from the FPU. Floating-point arithmetic instructions are executed in the FPU 314, and the FPU 314 reads and updates the MXCSR 310. The output 304 is the result of the arithmetic operations performed by the FPU 314. It should be appreciated that FIG. 3 shows the logical view/state of the processor.

Many modern processors support the standard logical view, in which only instructions 302 and the output 304 are seen by application and application programmers. However, internal operations may be different among different processors. For example, in order to provide high performance, instructions may be executed in a different order than the programmer specifies (this is called OUT-OF-ORDER EXECUTION). This is achieved via the use of an OUT-OF-ORDER EXECUTION engine, which is a hardware unit implemented inside the processor core.

Embodiments of the invention relate to an optimizer to expose the hardware of a Multimedia Extension Control and Status Register (MXCSR) of the processor core 274 to enable reordering, renaming, tracking, and exception checking to allow for the optimization of floating-point operations by applications and application programmers. In particular, the current logical view of the use of the MXCSR is supported and reserved, but the physical implementation is different from previous prior art implementations.

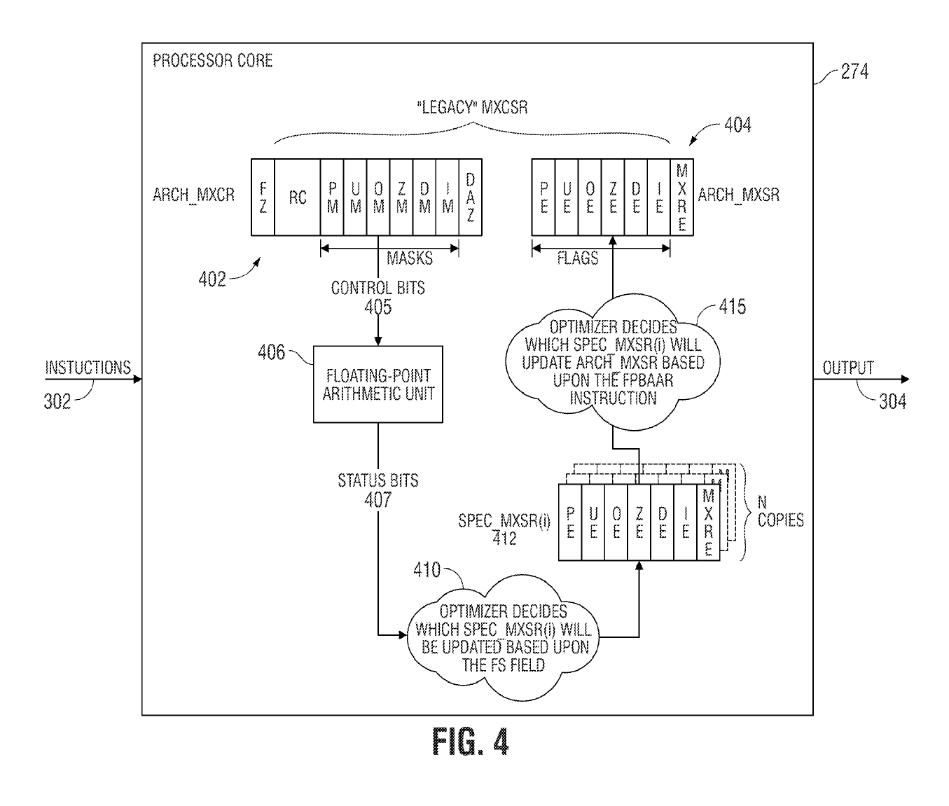

In one embodiment, a hardware component and an optimizer component (e.g., a virtual machine optimizer) are utilized. However, it should be appreciated that embodiment of the components disclosed herein may be implemented in hardware, software, firmware, or combinations thereof. Hereinafter, the term optimizer will be utilized. In particular, with reference to FIG. 4, the optimizer component 410, 415 in conjunction with hardware components may be responsible for controlling the physical state internal to the processor core 274 and for exporting the architectural state or logical view to the application or application programmer. In particular, optimizer 410,415 allows the application or application programmer to control reordering, renaming, tracking, and exception checking within the processor core 274 to allow the application or application programmer to optimize floating-point operations. In other words, the optimizer components 410, 415 allow the application or application programmer to optimize the performance of floating point operations performed by the FPU for instructions 302.

As an example, the processor core 274 may include a floating point unit (FPU) 406 to perform arithmetic functions and a multimedia extension control register (MXCR) 402 to provide control bits 405 to the FPU. Further an optimizer 410,415 may be used to select a speculative multimedia extension status register (SPEC_MXSR) from a plurality of SPEC_MXSRs 412 to update a multimedia extension status register (MXSR) 404 based upon an instruction 302. The instruction may be received from an application and/or an application programmer. The instruction may allow for reordering, renaming, tracking, and exception checking of FPU operations.

As shown in FIG. 4, the implementation may include two registers: architecture multimedia extension control register (ARCH_MXCR) 402 and architecture multimedia extension status register (ARCH_MXSR) 404. These registers, together, provide the ARCHITECTURAL STATE of the MXCSR (e.g., “Legacy” MXCSR). Briefly, ARCH_MXCR 402 may include the following entries: flash to zero (FZ); rounding control (RC); precision mask (PM); underflow mask (UM); overflow mask (OM); divide by zero mask (ZM); denormal mask (DM); invalid mask (IM); and denormal as zero (DAZ). ARCH_MXSR 404 may include the following entries: precision error (PE); underflow error (UE); overflow error (OE); divide by zero error (ZE); denormal error (DE); invalid error (IE); and multimedia extension real exception (MXRE). The MXRE is an additional bit to track pending exceptions.

The ARCH_MXCR register 402 provides the CONTROL bits 405 to the FPU 406. The FPU 406 provides the status bits 407 to optimizer 410. Optimizer 410 decides which speculative MXSR(i) (SPEC_MSXR(i)) 412 will be updated based upon a floating point staging field (FS). As shown in FIG. 4, there may up to N copies of SPEC_MSXR(i) 412. Thus, there are multiple copies of SPEC_MXSR(i) registers 412. The FPU 406 produces STATUS bits (as result of floating-point instruction execution) that update the SPEC_MXSR registers. All FPU instructions may be extended with a FS field. The optimizer 410 uses the FS field to specify which SPEC_MXSR register will receive the STATUS bits.

Next, optimizer 415 may decide which SPEC_MSXR(i) 412 will update ARCH_MXSR 404 based upon a Floating Point Barrier (FPBARR) instruction. This FPBARR instruction may be used to manage the multiple SPEC_MXSR 412 copies and ARCH_MXSR 404. Through the use of the FPBARR instruction, optimizer 415 may provide the ARCHITECTURAL MXCSR state (via ARCH_MXSR 404 and ARCH_MXCR 405) from the physical state of the selected SPEC_MXSR registers 412. In this way, either the application or the application programmer may select an instruction and a particular SPEC_MXSR register 412 for an FPU operation.

Accordingly, embodiments of the invention, by utilizing an optimizer (410, 415), allows for high performance implementation of floating-point program execution in a virtual machine environment, which allows an application or an application programmer to select the order of instructions for FPU operations, instead of the processor itself. In particular, the optimizer 410,415 allows the application or application programmer to control reordering, renaming, tracking, and exception checking within the processor core 274 to allow the application or application programmer to optimize floating-point operations. In other words, the optimizer components 410, 415 allow the application or application programmer to optimize the performance of floating point operations performed by the FPU for instructions.

A more detailed explanation of embodiments of the invention will be hereinafter described. In one aspect, embodiments of the invention may be considered to consist of three parts. The first part may be the hardware to hold multiple copies of the MXCSR state, the second may involve extensions and alterations to floating-point instruction behavior, and the third part may include the FPBARR instruction that, as previously described, allows the optimizer 410, 415 to manage the multiple SPEC_MXSR registers 412 and to check for arithmetic exceptions. Further, embodiments of the invention allow for the renaming of the MXCSR register through status updates.

As to part 1, the hardware to hold multiple copies of the MXCSR state is described. The state elements involved may be the following: a) One architectural copy of the control bits of MXCSR, such as fields—RC, FTZ, DAZ and MASKS—shown as ARCH_MXCR 402; b) One architectural copy of the status bits of MXCSR, such as—FLAGS and the MXRE bit to track pending exceptions—shown as ARCH_MXSR 404; c) A set of N speculative copies of the MXSR FLAGS plus the MXRE bit—termed SPEC_MXSR(i) 412. Is should be noted that at any given moment the MXCSR state can be re-constructed from ARCH_MXCR 402 and ARCH_MXSR 404 (ignoring the MXRE bit).

As to part 2, floating-point instructions may be extended with a FS field (as previously described) (e.g., an FS field may be an identifier of ceil(log₂N) bits). As previously described, the FS field may be used to specify or choose a SPEC_MSXR(i) 412 copy. As an example, when a floating-point instruction operates, it first reads the necessary control information from ARCH_MXCR 402 (for example the rounding mode to use, how to treat denormal numbers, etc.). At the end of the operation, the FPU 406 hardware produces along with the result of the operation, some arithmetic flags. These may be merged to the SPEC_MXSR(FS) FLAGS field by performing a logical OR operation, in a “sticky” manner. This means that the merge operation can change a FLAGS bit from ‘0’ to a ‘1’ but not the other way around. If during this merge the value of the i-th SPEC_MXSR(FS) FLAGS bit is changed from ‘0’ to ‘1’, and the i-th ARCH_MXCR MASKS bit is set to ‘0’, then the SPEC_MXSR(FS) MXRE bit may also be set to ‘1’ (also in a sticky manner). This means that this instruction should raise a floating-point exception, but instead of doing so immediately this action may be marked in the SPEC_MXSR(FS) register 412. This new behavior of floating-point operations, allows executing floating-point instructions speculatively, without altering any architectural state or raising any exceptions.

As to part 3, The FPBARR instruction implemented by the optimizer 415 may allow for managing the ARCH_MXCR register 404, ARCH_MXSR register 402 and the SPEC_MXSR registers 412, and it also allows for raising floating-point exceptions. In particular, the optimizer 415 utilizing the FPBARR instruction may accept several modifiers (i.e. operands) that specify particular actions to be performed. For example, multiple modifiers may be specified for the same instruction. Various actions for each modifier for FPBARR instructions will be hereinafter discussed individually and then interaction among all the modifiers will be described.

FPBARR #merge=<V>:

The #merge modifier specifies a N-bit wide bitmask value <V>, which is called the merge set. When the i-th bit in the merge set is asserted where 0 <<N, then the value of the SPEC_MXSR(i) register 412 is merged into ARCH_MXSR 404. The merge is done in a sticky manner. Any number of bits can be asserted and multiple concurrent merges may be allowed. When the merge set is empty (i.e. no bits asserted) no merge actions are performed. The merge operations include the FLAGS and the MXRE bits as well.

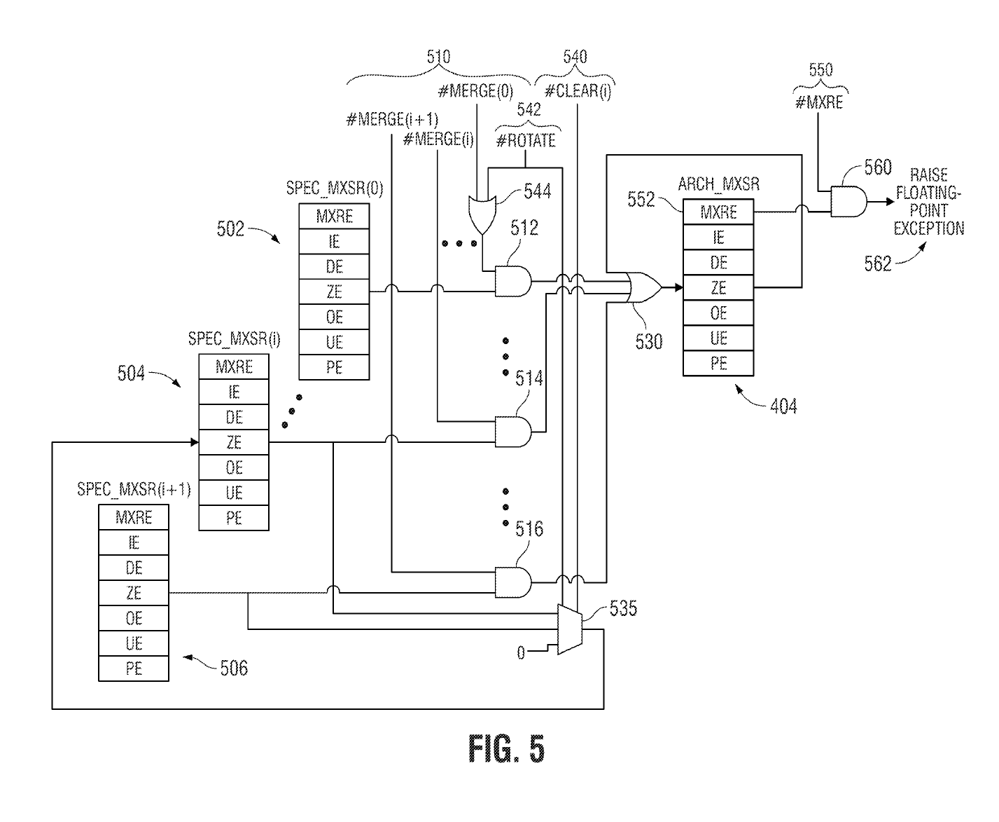

As an example, with reference to FIG. 5, various SPEC_MXSR(i) registers 502, 504, and 506 may be merged together via the FBARR instruction. FIG. 5 shows examples of the FBARR merge, rotate, clear, and MXRE instructions in digital gate form, as an illustration. For example, SPEC_MXSR(i) registers 502, 504, and 506 may be merged or not merged together based upon merge instructions 510 and corresponding And gates 512, 514, and 516. After combination with Or gate 530, the SPEC_MXSR(i) registers 502, 504, and 506 may be merged into ARCH_MXSR 404. For clarity, only a few of the SPEC_MXSR(i) registers are illustrated. Other instructions of FIG. 5 may also be implemented. For example, the SPEC_MXSR(i) registers 502, 504, and 506 may be cleared by implementation of a clear command 540 selected by selector(s) 535. The clear command to be hereinafter discussed in more detail. Additionally, a rotate command to be hereinafter discussed may also be selected by selector(s) 535, Or gate 544, Or gate 530, etc. Further, a multimedia extension real exception MXRE instruction 550 may be applied if a MXRE bit 552 is set through And gate 560. If the MXRE bit 552 is set and MXRE instruction 550 is implemented And gate 560 will issue a raise floating-point exception 562. This instruction will also be further described in detail.

FPBARR #clear=<V>:

The #clear instruction 540 specifies a N-bit wide bitmask value <V>, which is called the clear set. When the i-th bit in the clear set is asserted where 0≦i<N, then the SPEC_MXSR(i) register is cleared, i.e. its value is set to zero. Any number of bits can be asserted and multiple concurrent clears are allowed. When the clear set is empty (i.e. no bits asserted) no clear actions are performed.

FPBARR #rotate:

The #rotate instruction 542 performs a merge of SPEC_MXSR(0), a clear of SPEC_MXSR(N−1), and a logical renaming of all SPEC_MXSR(i) for 0≦i<N−1 registers. This particular operation can be best described in the following series of actions (in descending order of precedence):

ARCH_MXSR ←merge SPEC_MXSR(0)
SPEC_MXSR(0) ←SPEC_MXSR(1)
SPEC_MXSR(1) ←SPEC_MXSR(2)
. . .
SPEC_MXSR(N − 3) ←SPEC_MXSR(N − 2)
SPEC_MXSR(N − 2) ←SPEC_MXSR(N − 1)
SPEC_MXSR(N − 1) ←clear

FPBARR #mxre:

When the #mxre instruction 550 is used, FPBARR raises a floating-point exception 562 if the MXRE bit 552 in ARCH_MXSR 404 is asserted.

It should be appreciated that all three instructions (merge, rotate, mxre) may be combined into a single FPBARR instruction. Hereinafter are example steps, in descending order of precedence: 1. Merge instructions 510 are performed. These actions modify the value of ARCH_MXSR 404; 2. The first of the rotate instructions 542 are performed, e.g., the merging of SPEC_MXSR(0) 502 into ARCH_MXSR 404. This action modifies the value of ARCH_MXSR 404; 3. The mxre check instruction 550 is performed. If the newly updated ARCH_MXSR register 404 has a MXRE bit of “1” (this could be because of this or previous merge or rotate instructions), then a floating-point arithmetic exception 562 is raised and none of the following steps will be performed; 4. The rest of the rotate instructions 542 are performed. This means all the updates to the SPEC_MXSR registers; 5. The clear instructions 540 are performed. The clear set in this case refers to the new assignment of the SPEC_MXSR registers, after rotation, not to the original SPEC_MXSRs.

Described hereinafter is an example usage. The clear instruction 540 may be used for resetting the speculative MXCSR state at specific points in the program execution. The merge instruction 510 may be used for combining one or more speculative execution streams into the architectural state at specific points in the program execution. The rotate instruction 542 may be used for performing software-pipelining optimizations on loops.

With this mechanism the optimizer 410,415 implementing the FPBAAR instructions can freely re-order floating-point code, even across control flow instructions (e.g. conditional branches). As an example, the optimizer 410,415 implementing the FPBAAR instructions can follow a coloring algorithm. At the start of a region all SPEC_MXSR copies 412 may be cleared. Then, each contiguous block of code is assigned a color (a SPEC_MXSR copy). At all points where correct architectural state is required, the optimizer 410,415 attaches an appropriate FPBARR instruction to perform merge and mxre checking. Further, in order to calculate the correct merge set the optimizer 410,415 should track all possible code paths from the last FPBARR instruction (e.g., merge and clear) point to the current one. By knowing all the code paths the optimizer 410,415 knows which colors were touched and the optimizer can calculate which registers to merge.

Further, the rotation instruction 542 may be used by the optimizer 410,415 for pipelined loops. In this case, each original loop iteration participating in the pipelined loop kernel may be assigned a SPEC_MXSR 412 such that the i-th iteration is assigned SPEC MXSR(0), iteration i+1 is assigned SPEC_MXSR(1), . . . iteration i+m is assigned SPEC_MXSR(m), etc. Each instruction in the kernel may then be augmented with the appropriate FS, based on which iteration of the original loop the instruction belongs to. Further, a FPBARR instruction implemented by the optimizer 410,415 with rotate instruction may be inserted at the end of each kernel iteration, to re-assign SPEC MXSR names, for the next kernel iteration. It should be appreciated that these are just examples of usage of the optimizer.

Accordingly, embodiments of the invention, by utilizing an optimizer (410, 415), allows for high performance implementation of floating-point program execution in a virtual machine environment, which allows an application or an application programmer to select the order of instructions for FPU operations, instead of the processor itself. In particular, the optimizer 410,415 allows the application or application programmer to control reordering, renaming, tracking, and exception checking within the processor core 274 to allow the application or application programmer to optimize floating-point operations. In other words, the optimizer components 410, 415 allow the application or application programmer to optimize the performance of floating point operations performed by the FPU for instructions 302

Embodiments of different mechanisms disclosed herein, such as the optimizer 410,415, as well all of the other mechanisms, may be implemented in hardware, software, firmware, or a combination of such implementation approaches. Embodiments of the invention may be implemented as computer programs or program code executing on programmable systems comprising at least one processor, a data storage system (including volatile and non-volatile memory and/or storage elements), at least one input device, and at least one output device.

Program code may be applied to input data to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative data stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Such machine-readable storage media may include, without limitation, non-transitory, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the invention also include non-transitory, tangible machine-readable media containing instructions for performing the operations embodiments of the invention or containing design data, such as HDL, which defines structures, circuits, apparatuses, processors and/or system features described herein. Such embodiments may also be referred to as program products.

Certain operations of the instruction(s) disclosed herein may be performed by hardware components and may be embodied in machine-executable instructions that are used to cause, or at least result in, a circuit or other hardware component programmed with the instructions performing the operations. The circuit may include a general-purpose or special-purpose processor, or logic circuit, to name just a few examples. The operations may also optionally be performed by a combination of hardware and software. Execution logic and/or a processor may include specific or particular circuitry or other logic responsive to a machine instruction or one or more control signals derived from the machine instruction to store an instruction specified result operand. For example, embodiments of the instruction(s) disclosed herein may be executed in one or more the systems of FIGS. 1 and 2 and embodiments of the instruction(s) may be stored in program code to be executed in the systems. Additionally, the processing elements of these figures may utilize one of the detailed pipelines and/or architectures (e.g., the in-order and out-of-order architectures) detailed herein. For example, the decode unit of the in-order architecture may decode the instruction(s), pass the decoded instruction to a vector or scalar unit, etc.

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A processor core comprising:
a floating point unit (FPU) to perform arithmetic functions;
a multimedia extension control register (MXCR) to provide control bits to the FPU; and
an optimizer to select a speculative multimedia extension status register (SPEC_MXSR) from a plurality of SPEC_MXSRs to update a multimedia extension status register (MXSR) based upon an instruction.

2. The processor core of claim 1, wherein, the instruction is received from an application.

3. The processor core of claim 1, wherein, the instruction is received from an application programmer.

4. The processor core of claim 1, wherein, the instruction allows for reordering of FPU operations.

5. The processor core of claim 1, wherein, the instruction allows for exception checking for FPU operations.

6. The processor core of claim 1, wherein, the instruction allows for renaming of status bits of the MXCR.

7. A computer system comprising:
a memory control hub coupled to a memory; and
a processor coupled to the memory control hub comprising:
a floating point unit (FPU) to perform arithmetic functions;
a multimedia extension control register (MXCR) to provide control bits to the FPU; and
an optimizer to select a speculative multimedia extension status register (SPEC_MXSR) from a plurality of SPEC_MXSRs to update a multimedia extension status register (MXSR) based upon an instruction.

8. The computer system of claim 7, wherein, the instruction is received from an application.

9. The computer system of claim 7, wherein, the instruction is received from an application programmer.

10. The computer system of claim 7, wherein, the instruction allows for reordering of FPU operations.

11. The computer system of claim 7, wherein, the instruction allows for exception checking for FPU operations.

12. The computer system of claim 7, wherein, the instruction allows for renaming of status bits of the MXCR.

13. A method for controlling a multimedia extension control and status register (MXCSR) comprising:
providing control bits to a floating point unit (FPU) that performs arithmetic functions; and
selecting a speculative multimedia extension status register (SPEC_MXSR) from a plurality of SPEC_MXSRs to update a multimedia extension status register (MXSR) of the MXCSR based upon an instruction.

14. The method of claim 13, wherein, the instruction is received from an application.

15. The method of claim 13, wherein, the instruction is received from an application programmer.

16. The method of claim 13, wherein, the instruction allows for reordering of FPU operations.

17. The method of claim 13, wherein, the instruction allows for exception checking for FPU operations.

18. The method of claim 13, wherein, the instruction allows for renaming of status bits of the MXCSR.

19. A computer program product for controlling a multimedia extension control and status register (MXCSR) comprising:
a computer-readable medium comprising code for:
generating a plurality of a speculative multimedia extension status registers (SPEC_MXSRs) from a floating point unit (FPU) that performs arithmetic functions; and
selecting a SPEC_MXSR from the plurality of SPEC_MXSRs to update a multimedia extension status register (MXSR) of the MXCSR based upon an instruction.

20. The computer program product of claim 19, wherein, the instruction is received from an application.

21. The computer program product of claim 19, wherein, the instruction is received from an application programmer.

22. The computer program product of claim 19, wherein, the instruction allows for reordering of FPU operations.

23. The computer program product of claim 19, wherein, the instruction allows for exception checking for FPU operations.

24. The computer program product of claim 19, wherein, the instruction allows for renaming of status bits of the MXCSR.
